(19) United States
(12) Patent Application Publication
(10) Pub. No.: US 2007/0011384 A1
(43) Pub. Date: Jan. 11, 2007

(54) Computer expansion slot and design method thereof

(75) Inventor: Xiang Zhang, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/317,113

(22) Filed: Dec. 22, 2005

(30) Foreign Application Priority Data
Jul. 9, 2005 (CN) 200510035922.7

(51) Int. Cl. G06F 13/00

(52) U.S. Cl. 710/301

(57) ABSTRACT

A slot is configured as one of a first slot or a second slot. The slot includes a primary slot. The primary slot includes a series of pads. At least one pad has two branches. When the pad which has two branches is connected to one branch the slot performs as the first slot, and when the pad is connected to the other branch the slot performs as the second slot. The method of designing the slot includes the steps of: setting a primary slot on a printed circuit board, the primary slot including a series of pads; comparing the first slot configurations and the second slot configurations to identify the unshared pads; and setting two branches for each of the unshared pads, each of the unshared pads optionally connected to one of the two branches according to the first slot configuration or the second slot configuration.

### BACKGROUND OF THE INVENTION

1. Field of the Invention

The present invention relates to an expansion slot, and more particularly to a slot that can be optionally configured as different types of slots, and a design method thereof.

2. General Background

The demands of emerging peripheral Input/Output devices exceed the capability of the traditional PCI (Peripheral Component Interconnect) bus. Technical innovations such as faster CPU front side bus speeds, faster memory speeds, high-performance graphics, faster networking devices, faster storage devices, high-speed consumer devices, and other market requirements drive the need for greater internal system bandwidth.

Some high-speed buses are invented and used, such as the PCI express (Peripheral Component Interconnection Express) bus. PCI express bus establishes a point-to-point connection from chip to chip, or chip to adapter on a motherboard. This full-duplex, dedicated, scalable lane bus increases bandwidth, decreases latency, and allows devices to perform as they were meant to. A single lane (X1) of PCI express bus has a bandwidth of 250 MB/sec. By running multiple lanes, (up to X32), the bandwidth increases arithmetically. At the same time, the scale of different PCI express connectors increases from PCI express X1 slot to X32 slot.

Referring to FIGS. 1 and 2, what are shown are a conventional PCI express X1 slot 100 and a conventional PCI express X16 slot 200. A series of pads A1 to A18 and B1 to B18 are set along opposite edges of the PCI express X1 slot 100. A series of pads A1 to A82 and B1 to B82 are set along opposite edges of the PCI express X16 slot 200. These pads of the slots 100 and 200 comply with the industry standard of peripheral component interconnect express. Most of the corresponding pins of PCI express X1 and X16 slots are usually defined to connect to the same signals, and only a few corresponding pins are unshared and connected to different signals. Manufacturers often design a series of motherboards only parts of which are different. For example, a series of motherboards have different PCI express slots. In such situations, the manufactures need to design a different motherboard for each different PCI Express slot, which is time-consuming and adds to the cost of manufacturing.

Therefore, an expansion slot on a motherboard that can be optionally configured as different types of slots should be developed.

### SUMMARY

A slot is configured as one of a first slot or a second slot. The slot includes a primary slot. The primary slot includes a series of pads. At least one pad has two branches. When the pad which has two branches is connected to one branch the slot performs as the first slot, and when the pad is connected to the other branch the slot performs as the second slot. The method of designing the slot includes the steps of: setting a primary slot on a printed circuit board, the primary slot including a series of pads; comparing the first slot configuration with the second slot configuration to identify the unshared pads; and setting two branches for each of the unshared pads, each of the unshared pads can then be optionally connected to one of the two branches to perform as either the first slot or the second slot.

Other advantages and novel features will be drawn from the following detailed description of a preferred embodiment with attached drawings, in which:

### BRIEF DESCRIPTION OF THE DRAWINGS

FIG. 1 is a schematic view of a circuit of a conventional PCI express X1 slot;

FIG. 2 is a schematic view of a circuit of a conventional PCI express X16 slot;

FIG. 3 is a schematic view of a circuit of a slot of a preferred embodiment of the present invention serving as a PCI express X1 slot; and

FIG. 4 is a schematic view of a circuit of a slot of a preferred embodiment of the present invention serving as a PCI express X16 slot.

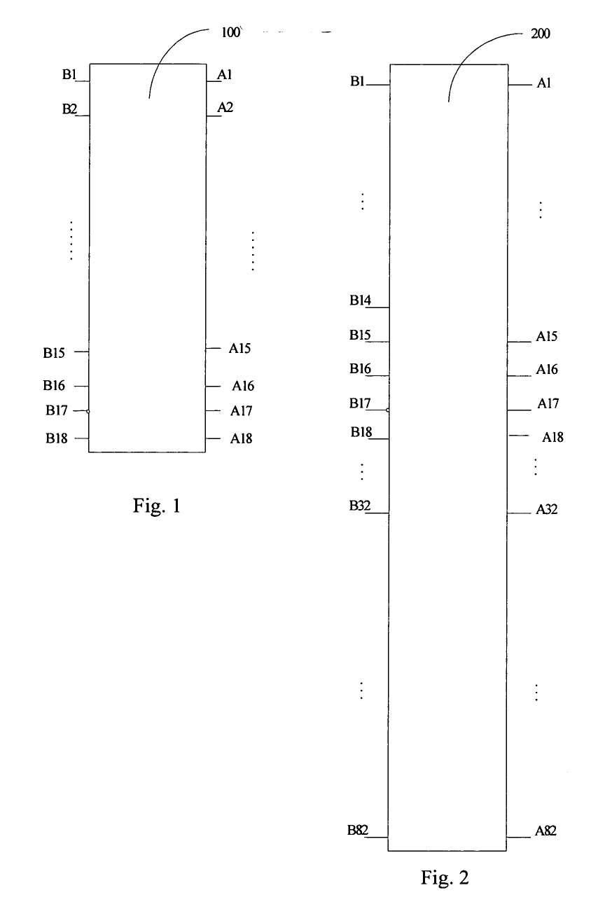

### DETAILED DESCRIPTION OF THE EMBODIMENTS

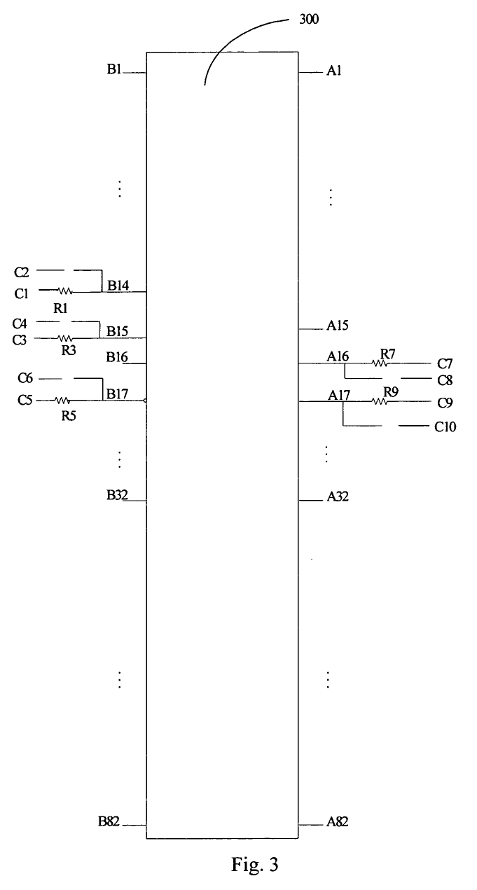

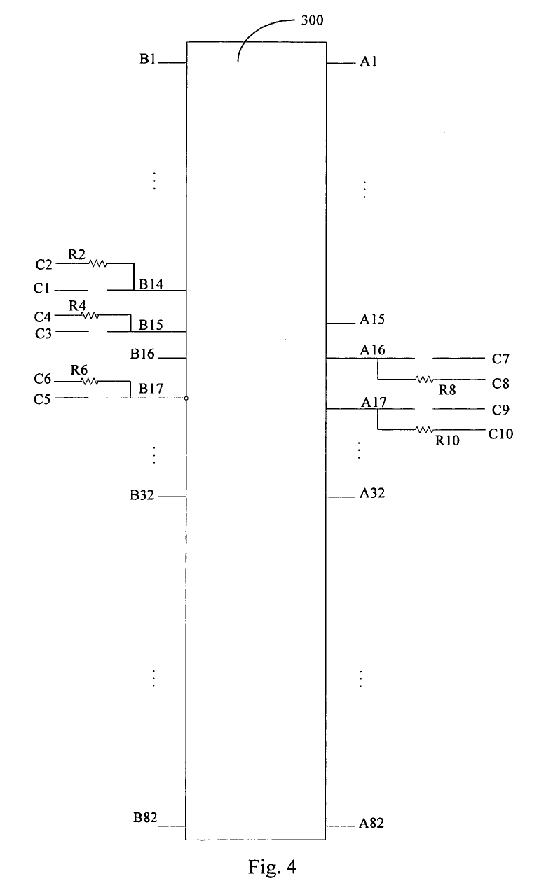

Referring to FIGS. 3 and 4, a computer expansion slot performed as an electrical connection interface in accordance with a preferred embodiment of the present invention is shown. In the embodiment, a slot 300 can be optionally assembled to perform as a PCI express X1 slot to connect with, for example, a network card with a PCI express X1 connector, or a PCI express X16 slot to connect with, for example, a graphics card with a PCI express X16 connector. The slot 300 is set on a printed circuit board (not shown). The slot 300 is similar to a conventional PCI express X16 slot defining a plurality of connection positions such as pads but with some pads of the slot 300 having two branches. In the slot 300, the pads A16, A17, B14, B15, and B17 are unshared, and each has two different branches with one branch providing a signal used in the PCI express X1 bus configuration and the other branch providing another signal used in the PCI express X16 bus configuration.

In FIG. 3, the slot 300 is configured to perform as the PCI express X1 slot. Branches C1, C3, C5, C7, and C9 each are connected to the corresponding pads of the slot 300 with resistors R1, R3, R5, R7, and R9 respectively. The resistors R1, R3, R5, R7, and R9 are zero ohm resistors.

In FIG. 4, the slot 300 is configured to perform as the PCI express X16 slot. Branches C2, C4, C6, C8, and C10 each are connected to the corresponding pads of the slot 300 with resistors R2, R4, R6, R8, and R10 respectively. The resistors R2, R4, R6, R8, and RIO are zero ohm resistors.

When the network card with a PCI express X1 connector needs to be mounted to the printed circuit board, the slot 300 is configured to perform as a PCI express X1 slot to mate with the network card. When the graphics card with a PCI express X16 connector needs to be mounted to the printed circuit board, the slot 300 is configured to perform as a PCI express X16 slot to mate with the graphics card.

In the above-mentioned embodiment, the PCI express X1 slot configuration and the PCI express X16 slot configuration are taken as a specific examples. However, the present invention is not limited thereto. For example, the PCI express X1, and X16 slot configurations can be other types of PCI express slot configurations (X2, X4, X8, X32 . . . ), or configurations for other types of slots, such as PCI extend slot, AGP slot, etc.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A slot that can be optionally configured to perform as one of a first slot or a second slot, the slot comprising:
a primary slot, the primary slot comprising a series of pads, at least one pad having two branches;
wherein when the pad which has two branches is connected to one branch the slot performs as a first slot, and when the pad is connected to the other branch the slot performs as a second slot.

2. The slot as described in claim 1, wherein the first slot and the second slot are configured as PCI express slots.

3. The slot as described in claim 1, wherein the first slot is configured as a PCI express X16 slot, and the second slot is configured as a PCI express X1 slot.

4. The slot as described in claim 3, wherein the first slot mates with a graphics card, and the second slot mates with a network card.

5. The slot as described in claim 3, wherein the primary slot comprises pads A1 to A82 and B1 to B82, in which pads A16, A17, B14, B15, and B17 each have two branches.

6. The slot as described in claim 1, wherein the pad connects to the branch through a resistor.

7. The slot as described in claim 6, wherein the resistor is a zero ohm resistor.

8. A method of designing a slot that can be optionally configured to perform as one of a first slot or a second slot, the method comprising the steps of:
setting a primary slot on a printed circuit board, the primary slot comprising a series of pads;
comparing the first slot configuration with the second slot configuration to identify the unshared pads; and
setting two branches for each of the unshared pads, each of the unshared pads optionally connected to one of the two branches according to the first slot configuration or the second slot configuration.

9. The method as described in claim 8, wherein the first slot and the second slot are PCI express slot configurations.

10. The method as described in claim 8, wherein the first slot is configured as a PCI express X16 slot, and the second slot is configured as a PCI express X1 slot.

11. The method as described in claim 10, wherein the first slot is for mating with a graphics card, and the second slot is for mating with a network card.

12. The method as described in claim 10, wherein the primary slot comprises pads A1 to A82 and B1 to B82, and the unshared pads comprise pads A16, A17, B14, B15, and B17.

13. The method as described in claim 8, wherein each unshared pad is connected to the branch through a resistor.

14. The method as described in claim 13, wherein the resistor is a zero ohm resistor.

15. A method to provide a common interface for electrical connection compatible with at least two different standards, comprising the steps of:
configuring an electrical connection interface to include a plurality of electrical connection positions satisfying at least two different standards for electrical connection respectively;
identifying unshared positions out of said plurality of positions in said interface based on definitions of said at least two standards; and
providing branch connections to each of said unshared positions corresponding to said at least two standards respectively.

16. The method as described in claim 15, wherein one of said branch connections corresponds to Peripheral Component Interconnect (PCI) express X16 standard and another of said branch connections corresponds to PCI express X1 standard.

17. The method as described in claim 15, further comprising the step of electrically connecting a selective one of said branch connections so as to be compatible with a preset one of said at least two standard.
